(19) United States
(12) Patent Application Publication
(10) Pub. No.: US 2006/0222060 A1
(43) Pub. Date: Oct. 5, 2006

(54) Transmission/reception signal conversion circuit and transmission/reception signal conversion method

(75) Inventor: Tsukasa Ueno, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/390,302

(22) Filed: Mar. 28, 2006

(30) Foreign Application Priority Data
Mar. 31, 2005 (JP) 102827/2005

(51) Int. Cl. H04L 5/16

(52) U.S. Cl. 375/219

(57) ABSTRACT

A transmission/reception signal conversion circuit, which can readily convert a signal level or a carrier frequency of a communication device without changing or adding an internal circuit of the communication device, is provided. The transmission/reception signal conversion circuit is connected between two communication devices, each of which communicates with each other, and the transmission/reception signal conversion circuit performs at least one of conversions of a signal level of a transmission signal, a signal level of a reception signal, a frequency of a transmission carrier signal, and a frequency of a reception carrier signal.

### BACKGROUND OF THE INVENTION

1. Field of the Invention

The present invention relates to a conversion circuit for signals, and more particularly, to a conversion circuit for transmission/reception signals of communication devices and thereof.

2. Description of the Related Art

Local area networks (LANs) are widely used in general households and offices as networks connecting between PCs and connecting between PCs and peripherals. In particular, wireless LANs (WLANs) are less restrictive in arrangement and replacement of WLAN devices, which are advantageous compared with conventional wired LANs, and are widely used.

Moreover, wireless communications as well as WLANs such as mobile phones and Bluetooth devices provide large benefit in practice, and are prevailing.

First, a description is given of an overview of a circuit configuration and an operation of a WLAN device. FIG. 4 shows a circuit configuration of a general WLAN device. A WLAN device includes, for example, a WLAN card which is generally used presently. A WLAN device 10A includes a data processing circuit (not shown), a transmission/reception control circuit 16, a transmission circuit 21, a reception circuit 20, a switch 24, and an antenna 26.

The transmission/reception control circuit 16 provides control to communicate reception data 14 and transmission data 15 with the data processing circuit which applies predetermined data processing to the data. In other words, transmission/reception control circuit 16 receives the transmission data 15 from the data processing circuit, and outputs transmission data 18 to the transmission circuit 21. Moreover, transmission/reception control circuit 16 receives reception data 17 from the reception circuit 20, and outputs the reception data 14 to the data processing circuit.

Transmission circuit 21 receives the transmission data 18 from transmission/reception control circuit 16, applies modulation, frequency conversion, amplification, and the like to transmission data 18, and outputs a resulting high frequency transmission signal 23. The high frequency transmission signal 23 passes the switch 24, becomes a high frequency transmission/reception signal 25, and is transmitted as a wireless transmission signal 27 via the antenna 26. The wireless transmission signal 27 is a wireless signal (radio signal) received by other WLAN devices (not shown).

Antenna 26 receives a wireless reception signal 28, and outputs the high frequency transmission/reception signal 25. The wireless reception signal 28 is a wireless signal (radio signal) transmitted by another WLAN device (not shown) Reception circuit 20 receives high frequency transmission reception signal 25 as a high frequency reception signal 22 via switch 24, applies amplification, frequency conversion, demodulation, and the like to the high frequency reception signal 22, and passes the reception data 17 to transmission/reception control circuit 16.

A transmission/reception mode control signal 19 is a binary signal outputted by transmission/reception control circuit 16 at a predetermined timing, and sets switch 24 to a transmission mode or a reception mode. For example, switch 24 connects transmission circuit 21 and antenna 26 with each other when the transmission/reception mode control signal 19 is at a low level, and connects reception circuit 20 and antenna 26 when transmission/reception mode control signal 19 is at a high level. As a result of this control of the transmission/reception modes, high frequency transmission signal 23 becomes high frequency transmission/reception signal 25, and is outputted to antenna 26, or high frequency transmission/reception signal 25 becomes high frequency reception signal 22, and is received by reception circuit 20.

Described above is the overview of the circuit configuration and the operation of the WLAN device.

By the way, there are various standards and specifications about carrier frequencies, transmission power and receive sensitivity closely related to the possible distance of the transmission, what is called “coverage”, and the like for WLAN devices. Therefore, when a WLAN device is newly installed, the carrier frequency, the transmission power and the receive sensitivity, and the like thereof may not conform to those of existing WLAN devices. This problem has conventionally been solved by changing transmission circuit 21 and reception circuit 20 of one of the wireless devices.

However, the conventional method to change reception circuit 20 and transmission circuit 21 cannot be simply employed if an internal configuration of WLAN device 10A cannot be readily changed. Moreover, even if reception circuit 20 and transmission circuit 21 can be changed, the change of reception circuit 20 and transmission circuit 21 requires work of an expert engineer, and there thus poses a problem of complex operation to change.

To address the inconformity of the transmission power and receive sensitivity, what is called a booster which amplifies the transmission/reception powers is used (refer to Japanese Patent application Laid-open No. 2002-325050 A). A booster described in JP 2002-325050 A is a booster for a WLAN, and compensates for a loss in a reception signal due to a cable connecting a WLAN device and an antenna with each other by amplifying the reception signal by means of a high frequency amplifier.

For this booster, it is assumed that, in order to compensate for a loss in a transmission signal, the level of an output signal from a transmitter is increased. Thus, this booster simply outputs the transmission signal from an antenna during transmission.

The booster described in JP 2002-325050 A can address the problem of the inconformity of the reception power or receive sensitivity. However, this booster does not necessarily address the problem of the mismatch of the transmission power. This is because it is necessary to change the level of the output signal of the transmitter to a proper level in order to change the level of the output signal for the conformity of the output signal. The change of the output level of the transmitter requires work of an expert engineer as in the above-described change of the transmitter and the receiver of general WLAN devices.

In order to change the level of the output signal, there may be employed a transceiver whose transmission level can be changed. However, the change is possible only within an expected range of the transmission level, and cannot be applied to the change beyond the range.

Moreover, the booster and the transceiver using the booster only amplify the transmission/reception signals, and cannot address a problem of inconformity with parameters of other WLAN devices other than transmission power or reception power such as the carrier frequency.

The above problems are not specific to WLANs, but also relate to entire wireless communication devices. Moreover, a wired communication device communicates transmission/reception signals compliantly to standards and specifications of other communication devices, and there may thus occur a similar problem.

As described above, there is no technology which readily adapts inconsistent parameters of signals transmitted/received between communication devices such as the transmission power receive sensitivity and the carrier frequency to those of standards and specifications of other communication devices.

### SUMMARY OF THE INVENTION

The present invention was made to solve the foregoing and other exemplary problems, drawbacks, and disadvantages of the conventional structures.

In view of the problems, drawbacks, and disadvantages, a first exemplary feature of the present invention is to provide a transmission/reception signal conversion circuit which can readily convert levels of transmission/reception signals of a communication device without a change or addition of an internal circuit of the communication device or work of an expert engineer.

A second exemplary feature of the present invention is to provide a transmission/reception signal conversion circuit which can readily convert a carrier frequency of a communication device without a change or addition of an internal circuit of the communication device or work of an expert engineer.

A third exemplary feature of the present invention is to provide a transmission/reception signal conversion method which can readily convert levels of transmission/reception signals of a communication device without a change or addition of an internal circuit of the communication device or work of an expert engineer.

In an exemplary embodiment of the present invention to attain the above and other exemplary purposes, a transmission/reception signal conversion circuit includes:

a transmission circuit for inputting a first transmission signal to be transmitted from a first communication device to a second communication device, and outputting a second transmission signal to the second communication device; a reception circuit for receiving a first reception signal to be transmitted from the second communication device to the first communication device, and outputting a second reception signal to the first communication device; a transmission signal detection circuit for measuring a signal level of the first transmission signal. And in based on the signal level, the transmission circuit outputs the second transmission signal to the second communication device or the reception circuit outputs the second reception signal to the first communication device. And the transmission circuit amplifies or attenuates the first transmission signal and then outputs the amplified or attenuated first transmission signal as the second transmission signal, and/or the reception circuit amplifies or attenuates the first reception signal and then outputs the amplified or attenuated first reception signal as the second reception signal.

In another exemplary embodiment of the present invention to attain the above and other exemplary purposes, a transmission/reception signal conversion circuit includes: a transmission circuit for inputting a first transmission signal to be transmitted from a first communication device to a second communication device, and outputting a second transmission signal to the second communication device; a reception circuit for receiving a first reception signal to be transmitted from the second communication device to the first communication device, and outputting a second reception signal to the first communication device; a transmission signal detection circuit for measuring a signal level of the first transmission signal. And in based on the signal level, the transmission circuit outputs the second transmission signal to the second communication device or the reception circuit outputs the second reception signal to the first communication device. And the first transmission signal and the first reception signal are modulated signals including a carrier at predetermined frequencies. And the transmission circuit converts the frequency of the carrier in the first transmission signal and then outputs the converted first transmission signal as the second transmission signal, and/or the reception circuit converts the frequency of the first reception signal and then outputs the converted first reception signal as the second reception signal.

In another exemplary embodiment of the present invention to attain the above and other exemplary purposes, a transmission/reception signal conversion method includes: a steps of inputting a first transmission signal to be transmitted from a first communication device to a second communication device; a steps of receiving a first reception signal to be received from the second communication device to the first communication device; a steps of amplifying or attenuating the first transmission signal as the second transmission signal and/or amplifying or attenuating the first reception signal as the second reception signal; a steps of measuring a signal level of the first transmission signal; and a steps of transmitting the second transmission signal to the second communication device or outputting the second reception signal to the first communication device, based on the signal level.

In the present invention, there is an advantage that a transmission/reception signal conversion circuit and the method can convert the levels of the transmission/reception signals and the carrier frequency by selecting a transmission circuit or a reception circuit according to presence/absence of the transmission signal outputted from the communication device, without work of an expert engineer.

Moreover, in the present invention, there is an advantage that it is not necessary to adapt transmission/reception circuits of the communication device to respective communication standards, and it is possible to employ transmission/reception circuits common to multiple communication standards.

### BRIEF DESCRIPTION OF THE DRAWINGS

The above and other exemplary purposes, features and advantages of the present invention will become more apparent form the following detailed description when taken in conjunction with the accompanying drawings wherein:

FIG. 1 is a block diagram of internal configurations of a transmission/reception signal conversion circuit according to a first exemplary embodiment and a second exemplary embodiment of the present invention, and a WLAN device connected thereto;

FIG. 2 is a flowchart showing a process of the transmission/reception signal conversion circuit shown in FIG. 1;

FIG. 3 is a block diagram of internal configurations of a transmission/reception signal conversion circuit according to a third exemplary embodiment of the present invention, and of a case where a WLAN device connected to an antenna is connected to the transmission/reception signal conversion circuit; and

FIG. 4 is a block diagram of an internal configuration of a conventional WLAN device.

### DETAILED DESCRIPTION OF THE EXEMPLARY EMBODIMENTS

### 1. First Exemplary Embodiment

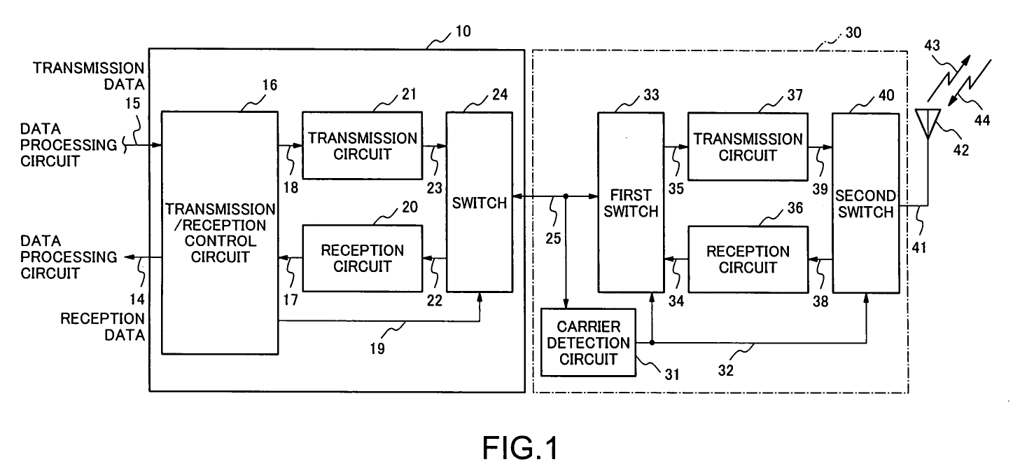

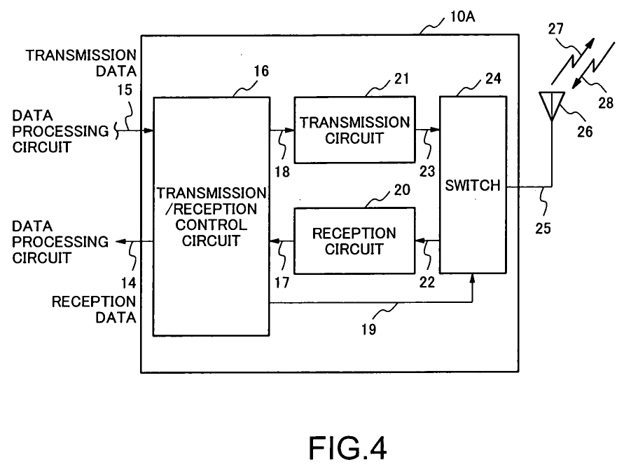

Hereinafter, a description will now be given of embodiments of the present invention with reference to drawings. FIG. 1 shows internal configurations of a transmission/reception circuit 30 according to a first embodiment of the present invention, and a WLAN device 10 to which the transmission/reception circuit 30 is connected. The WLAN device 10 has the internal configuration similar to that of WLAN device 10A shown in FIG. 4 except that antenna 26 is not connected. Moreover, an operation of WLAN device 10 is similar to that of WLAN device 10A, and a duplicate description thereof is therefore omitted. WLAN device 10 according to the present embodiment transmits a high frequency transmission/reception signal 25 with a transmission power of 0 dBm during transmission, and receives a high frequency transmission/reception signal 25 with a reception power equal to or less than −3 dBm upon reception.

Transmission/reception conversion circuit 30 includes a carrier detection circuit 31, a first switch 33, a transmission circuit 37, a reception circuit 36, and a second switch 40. Moreover, an antenna 42 is connected to a second switch 40.

The transmission circuit 37 and the reception circuit 36 have a signal amplification function. For example, if transmission circuit 37 serves as a power amplifier, WLAN device 10 can be used as a high-powered device without changing the internal configuration thereof. The power amplifier can output a wireless signal with a power equal to or more than 20 dBm. Reception circuit 36 amplifies an input signal so as to have an output signal level equal to or less than −3 dBm, and outputs the amplified signal to WLAN device 10.

A transmission/reception mode control signal 32 is a binary signal outputted by the carrier detection circuit 31, and sets the first switch 33 and the second switch 40 to a transmission mode or a reception mode. For example, the transmission/reception mode control signal 32 is set at a low level in the transmission mode, and is set at a high level in the reception mode.

In the transmission mode, signal paths of first switch 33 and second switch 40 are switched to a side of transmission circuit 37. In other words, first switch 33 outputs a high frequency transmission/reception signal 25 to transmission circuit 37 as a high frequency transmission signal 35. Transmission circuit 37 amplifies the high frequency transmission signal 35, and outputs the amplified signal as a high frequency transmission signal 39 to second switch 40. Second switch 40 outputs the high frequency transmission signal 39 as a high frequency transmission/reception signal 41 to the antenna 42. Antenna 42 outputs the high frequency transmission/reception signal 41 as a wireless transmission signal 43. The wireless transmission signal 43 is a wireless signal (radio signal) received by other WLAN devices (not shown).

In the reception mode, the signal paths of first switch 33 and second switch 40 are switched to a side of reception circuit 36. In other words, second switch 40 outputs a high frequency transmission/reception signal 41 to reception circuit 36 as a high frequency reception signal 38. Reception circuit 36 amplifies the high frequency reception signal 38, and outputs the amplified signal as a high frequency-reception signal 34 to first switch 33. First switch 33 outputs the high frequency reception signal 34 as a high frequency transmission/reception signal 25 to WLAN device 10.

Carrier detection circuit 31 always monitors a power level of the high frequency transmission/reception signal 25 outputted from WLAN device 10. When carrier detection circuit 31 detects high frequency transmission/reception signal 25 with the power level exceeding −1 dBm, carrier detection circuit 31 determines that WLAN device 10 has outputted high frequency transmission/reception signal 25, and sets first switch 33 and second switch 40 to the transmission mode. On this occasion, transmission circuit 37 amplifies high frequency transmission/reception signal 25 inputted from WLAN device 10, and transmits wireless transmission signal 43 with the power level equal to or more than 20 dBm via antenna 42.

When the power level of high frequency transmission/reception signal 25 becomes −1 dBm or less, carrier detection circuit 31 determines that WLAN device 10 has completed the transmission, and sets first switch 33 and second switch 40 to the reception mode. On this occasion, reception circuit 36 goes into a state to receive a wireless reception signal 44 via the antenna 42. The wireless reception signal 44 is a wireless signal (radio signal) transmitted by another WLAN device (not shown). Reception circuit 36 receives a high frequency transmission/reception signal 41, which antenna 42 generates from wireless reception signal 44, via second switch 40, amplifies/attenuates the high frequency transmission/reception signal 41, and outputs a resulting signal as a high frequency transmission/reception signal 25 to WLAN device 10. High frequency transmission/reception signal 25 has been converted by reception circuit 36 to a signal with a power equal to or less than −3 dBm, and is outputted to WLAN device 10. The power of high frequency transmission/reception signal 25 is equal to or less than −3 dBm, carrier detection circuit 31 doesn't determine that WLAN device 10 has outputted high frequency transmission/reception signal 25.

In this way, according to the first embodiment, the switching to the transmission mode or the reception mode is determined according to whether the power level of high frequency transmission/reception signal 25 from WLAN device 10 exceeds −1 dBm or not. Then, according to the determined mode, either the path via transmission circuit 37 or the path via reception circuit 36 is selected as the signal path.

It should be noted that both transmission circuit 37 and reception circuit 36 may not have amplification functions, and either transmission circuit 37 or reception circuit 36 may have an amplification function. Alternatively, transmission circuit 37 or reception circuit 36 may have an attenuation function instead of amplification functions if necessary.

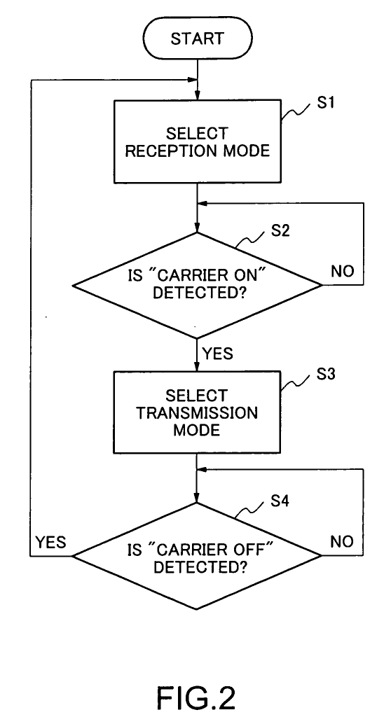

The operation of the first embodiment is described in more detail with reference to a flowchart. FIG. 2 is a flowchart showing a process of transmission/reception signal conversion circuit 30 according to the first embodiment. Transmission/reception signal conversion circuit 30 selects the reception mode when transmission/reception signal conversion circuit 30 starts the operation (Step S1). Thus, carrier detection circuit 31 sets transmission/reception mode control signal 32 to the low level, and first switch 33 and second switch 40 select the paths which set reception circuit 36 effective.

Then, carrier detection circuit 31 detects the power level of high frequency transmission/reception signal 25 to determine the presence/absence of high frequency transmission/reception signal 25 from WLAN device 10 (Step S2). In Step S2, if the power level exceeds −1 dBm, carrier detection circuit 31 determines that high frequency transmission/reception signal 25 is being outputted, namely a state of “carrier on” is present. If the power level is equal to or less than −1 dBm, carrier detection circuit 31 determines that high frequency transmission/reception signal 25 is not being outputted, namely a state of “carrier off” is present.

In Step S2, if carrier detection circuit 31 determines the presence of “carrier on”, carrier detection circuit 31 selects the transmission mode. On this occasion, first switch 33 and second switch 40 are switched to the paths to set transmission circuit 37 effective (Step S3).

In Step S2, if carrier detection circuit 31 determines the presence of “carrier off”, the reception mode is maintained.

After the execution of Step S3, carrier detection circuit 31 continues the detection of the power level of high frequency transmission/reception signal 25. And if carrier detection circuit 31 determines the presence of “carrier off” (Step S4), carrier detection circuit 31 returns to Step S1 and changes first switch 33 and second switch 40 to the reception mode.

In Step S4, if carrier detection circuit 31 determines the presence of “carrier on”, carrier detection circuit 31 maintains the transmission mode.

As described above, transmission/reception signal conversion circuit 30 according to the first embodiment switches between transmission circuit 37 and reception circuit 36 according to the power level of high frequency transmission/reception signal 25 from WLAN device 10. Moreover, transmission circuit 37 and reception circuit 36 have signal amplification functions, transmission/reception signal conversion circuit 30 can adapt the transmission power level and the reception power level of WLAN device 10 to other WLAN devices. It is apparent that when the power of the WLAN device is increased, the coverage is extended.

Moreover, on this occasion, it is not necessary to change the internal configurations of WLAN device 10, and it is possible to change WLAN device 10 to a high-powered device by changing the connection between the antenna and the switch simply. “Changing the connection” means removing the original antenna of WLAN device 10 and connecting switch 24 to transmission/reception signal conversion circuit 30. Moreover, when WLAN devices with various powers or various sensitivities are provided in addition to an ordinary WLAN device, it is not necessary to change the transmission/reception circuits of the WLAN devices and it is possible to use common transmission/reception circuits in the WLAN devices.

### 2. Second Embodiment

Transmission circuit 37 and reception circuit 36 of transmission/reception signal conversion circuit 30 of the first embodiment has amplification or attenuation functions. But the functions which transmission circuit 37 and reception circuit 36 can have are not limited to amplification or attenuation functions. One or both of transmission circuit 37 and reception circuit 36 may have a frequency conversion function. If transmission circuit 37 and reception circuit 36 have a frequency conversion function, WLAN device 10 can be used as a WLAN device adapted to a carrier frequency different from the original carrier frequency of WLAN device 10. It is apparent that transmission circuit 37 and reception circuit 36 may have amplification functions or attenuation functions in addition to the frequency conversion function.

A description will now be given of an operation of transmission/reception signal conversion circuit 30 according to the second embodiment with reference to FIG. 1. A basic operation of transmission/reception signal conversion circuit 30 of the second embodiment is similar to that of the first embodiment. And only functions of transmission circuit 37 and reception circuit 36 are different, and transmission circuit 37 and reception circuit 36 have frequency conversion functions. Carrier detection circuit 31 always monitors the power level of high frequency transmission/reception signal 25 outputted from WLAN device 10. If carrier detection circuit 31 determines the presence of “carrier on”, first switch 33 and second switch 40 are set to the transmission mode. On this occasion, transmission circuit 37 converts a carrier frequency of high frequency transmission/reception signal 25 inputted from WLAN device 10 from the original carrier frequency to one of predetermined carrier frequencies provided for communicating with other WLAN device using different carrier frequency, and transmits a resulting signal as wireless transmission signal 43 via antenna 42.

High frequency transmission/reception signal 25 and high frequency transmission signal 35 are “modulated signals”. A modulated signal is a “carrier signal” modulated by a “modulating signal” which contains information. The frequency of high frequency transmission/reception signal 35 is converted to another one by transmission circuit 37 and become high frequency transmission signal 39. High frequency transmission signal 39 becomes high frequency transmission/reception signal 41 and is transmitted as wireless transmission signal 43 via second switch 40 and antenna 42.

If carrier detection circuit 31 determines the presence of “carrier off”, first-switch 33 and second switch 40 are set to the reception mode. On this occasion, reception circuit 36 receives a high frequency transmission/reception signal 41, which antenna 42 generates from a received wireless reception signal 44, via second switch 42, converts the carrier frequency thereof, and outputs a resulting signal as a high frequency transmission/reception signal 25 to WLAN device 10.

High frequency transmission/reception signal 41 and high frequency reception signal 38 are modulated signals. The frequency of high frequency reception signal 38 is converted to another one by reception circuit 36 and become high frequency reception signal 34. High frequency reception signal 34 becomes high frequency transmission/reception signal 25 and is outputted to WLAN device 10.

In this way, according to the second embodiment, the mode is determined as the transmission mode or the reception mode according to whether the high frequency transmission/reception signal 25 in the state of “carrier on” or “carrier off”. Then, according to the determined mode, either the path via transmission circuit 37 or the path via reception circuit 36 is selected as the signal path.

It should be noted that both transmission circuit 37 and reception circuit 36 may not have frequency conversion functions, and either transmission circuit 37 or reception circuit 36 may have a frequency conversion function.

As described above, transmission/reception signal conversion circuit 30 according to the second embodiment switches between transmission circuit 37 and reception circuit 36 according to the power level of high frequency transmission/reception signal 25 from WLAN device 10. Transmission circuit 37 and reception circuit 36 have frequency conversion functions and transmission/reception signal conversion circuit 30 can adapt the carrier frequency of WLAN device 10 to that of other WLAN devices.

Moreover, on this occasion, it is not necessary to change the internal configurations of WLAN device 10, and it is possible to change the carrier frequency by changing the connection between the antenna and the switch simply. “Changing the connection” means removing the original antenna of WLAN device 10 and connecting switch 24 to transmission/reception signal conversion circuit 30.

When plural kinds of WLAN devices adapted to the different carrier frequencies are provided, it is not necessary to change the transmission/reception circuits of the WLAN devices and it is possible to use common transmission/reception circuits in the WLAN devices.

And also when wireless LAN devices with high power outputs or different carrier frequencies are provided, it is possible to use common transmission/reception circuits in the WLAN devices.

### 3. Third Embodiment

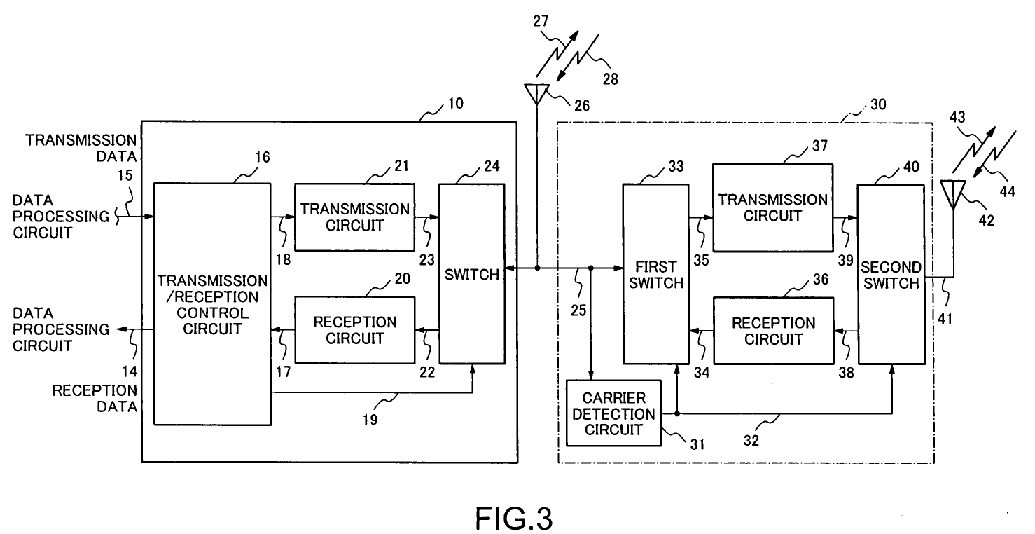

If transmission circuit 37 is configured as a frequency conversion circuit as in the second embodiment, transmission/reception signal conversion circuit 30 can be connected to WLAN device 10 while an antenna 26 of WLAN device 10 remains connected. FIG. 3 is a block diagram showing an internal configuration when transmission/reception signal conversion circuit 30 is connected to WLAN device 10 while the antenna 26 remains connected to WLAN device 10. A wireless transmission signal 27 is directly outputted from antenna 26. A wireless transmission signal 43 outputted from transmission/reception signal conversion circuit 30 is outputted from antenna 42. Though the wireless transmission signal 27 and the wireless transmission signal 43 are outputted simultaneously, they have carrier frequencies different from each other, and the signals thus do not interfere with each other.

According to the configuration of the third embodiment, it is possible to transmit wireless transmission signal 43 to WLAN devices which has a different two carrier frequency, and it is also possible to connect transmission/reception signal conversion circuit 30 to WLAN device 10 while antenna 26 remains connected. Thus, it is possible to transmit the wireless transmission signal to multiple WLAN devices which have different carrier frequencies.

The description has been given of the embodiments for connecting the transmission/reception signal conversion circuit according to the present invention to WLAN devices, but the transmission/reception signal conversion circuit according to the present invention is not limited to the configurations of the above embodiments. In other words, the transmission/reception signal conversion device according to the present invention may be connected to general wireless communication devices as well as WLAN devices.

Moreover, the transmission/reception signal conversion device according to the present invention may be connected to wired communication devices. In other words, the transmission/reception signal conversion device according to the present invention may be applied to a communication device which carries out the transmission of the transmission signal and the reception of the reception signal, which are exclusive to each other, via a single medium.

While this invention has been described in connection with certain exemplary embodiments, it is to be understood that the subject matter encompassed by way of this invention is not to be limited to those specific embodiments. On the contrary, it is intended for the subject matter of the invention to include all alternatives, modifications and equivalents as can be included within the spirit and scope of the following claims.

Further, it is the inventor's intent to retain all equivalents of the claimed invention even if the claims are amended during prosecution.

This application is based on Japanese Patent Application No. 2005-102827 filed on Mar. 31, 2005, and including specification, claims, drawings and summary. The disclosure of the above Japanese Patent Application is incorporated herein by reference in its entirety.

What is claimed is:

1. A transmission/reception signal conversion circuit, which is connected between a first communication device and a second communication device, comprising:
a transmission circuit, which inputs a transmission signal transmitted from the first communication device, converts a signal level of the transmission signal to a first predetermined level required for communicating with the second communication device, and outputs the converted transmission signal to the second communication device;
a reception circuit, which receives a reception signal received from the second communication device; and
a transmission signal detection circuit, which measures a signal level of the transmission signal, and provides a mode change signal when the signal level of the transmission signal is higher than a second predetermined level,
wherein, the transmission circuit is enabled when the mode change signal is provided and the reception circuit is enabled when the mode change signal is not provided.

2. A transmission/reception signal conversion circuit, which is connected between a first communication device and a second communication device, comprising:
a transmission circuit, which inputs a transmission signal transmitted from the first communication device;
a reception circuit, which receives a reception signal transmitted from the second communication device, converts a signal level of the reception signal to a third predetermined level required for communicating with the first communication device, and outputs the converted reception signal to the first communication device; and
a transmission signal detection circuit, which measures a signal level of the transmission signal, and provides a mode change signal when the signal level of the transmission signal is higher than a second predetermined level,
wherein, the transmission circuit is enabled when the mode change signal is provided and the reception circuit is enabled when the mode change signal is not provided.

3. The transmission/reception signal conversion circuit according to claim 1, further comprising:
a switch circuit, which is connected to the transmission signal detection circuit, and enables one of the transmission circuit and the reception circuit depending on receiving state of the mode change signal.

4. The transmission/reception signal conversion circuit according to claim 2, further comprising:
a switch circuit, which is connected to the transmission signal detection circuit, and enables one of the transmission circuit and the reception circuit depending on receiving state of the mode change signal.

5. A transmission/reception signal conversion circuit, which is connected between a first communication device and a second communication device, comprising:
a transmission circuit, which inputs a transmission carrier signal transmitted from the first communication device, converts a frequency of the transmission carrier signal to a first predetermined frequency required for communicating with the second communication device, and outputs the converted transmission carrier signal to the second communication device;
a reception circuit, which receives a reception signal transmitted from the second communication device; and
a transmission signal detection circuit, which measures a signal level of a transmission signal inputted from the first communication device, and provides a mode change signal when the signal level of the transmission signal is higher than a first predetermined level,
wherein, the transmission circuit is enabled when the mode change signal is provided and the reception circuit is enabled when the mode change signal is not provided.

6. A transmission/reception signal conversion circuit, which is connected between a first communication device and a second communication device, comprising:
a transmission circuit, which inputs a transmission signal transmitted from the first communication device;
a reception circuit, which receives a reception carrier signal received from the second communication device, converts a frequency of the reception carrier signal to a second predetermined frequency required for communicating with the first communication device, and outputs the converted reception carrier signal to the first communication device; and
a transmission signal detection circuit, which measures a signal level of the transmission signal, and provides a mode change signal when the signal level of the transmission signal is higher than a first predetermined level,
wherein, the transmission circuit is enabled when the mode change signal is provided and the reception circuit is enabled when the mode change signal is not provided.

7. The transmission/reception signal conversion circuit according to claim 5, further comprising:
a switch circuit, which is connected to the transmission signal detection circuit, and enables one of the transmission circuit and the reception circuit depending on receiving state of the mode change signal.

8. The transmission/reception signal conversion circuit according to claim 6, further comprising:
a switch circuit, which is connected to the transmission signal detection circuit, and enables one of the transmission circuit and the reception circuit depending on receiving state of the mode change signal.

9. The transmission/reception signal conversion circuit according to claim 7, wherein both of the first and second communication devices are wireless communication devices with respective antennas for signal transmission and reception, and an input path of the transmission signal from the first communication device and an output path of the reception signal to the first communication device are connected in common with the antenna of the first communication device.

10. The transmission/reception signal conversion circuit according to claim 8, wherein both of the first and second communication devices are wireless communication devices with respective antennas for signal transmission and reception, and an input path of the transmission signal from the first communication device and an output path of the reception signal to the first communication device are connected in common with the antenna of the first communication device.

11. A transmission/reception signal conversion method of converting transmission/reception signals exchanged between a first communication device and a second communication device, comprising:
measuring a signal level of a transmission signal inputted from the first communication device at a transmission signal detection circuit; and
enabling one of a transmission circuit and a reception circuit depending on the signal level of the transmission signal having been measured;
wherein, when the transmission circuit is enabled, the transmission circuit converts a signal level of the transmission signal to a first predetermined level required for communicating with the second communication device and outputting the converted transmission signal to the second communication device.

12. A transmission/reception signal conversion method of converting transmission/reception signals exchanged between a first communication device and a second communication device, comprising:
measuring a signal level of a transmission signal inputted from the first communication device at a transmission signal detection circuit; and
enabling one of a transmission circuit and a reception circuit depending on the signal level of the transmission signal having been measured;
wherein, when the reception circuit is enabled, the reception circuit converts a signal level of the reception signal transmitted from the second communication device to a second predetermined level required for communicating with the first communication device and outputting the converted reception signal to the first communication device.

13. The transmission/reception signal conversion method according to claim 11, further comprising:
providing a mode change signal, at the transmission signal detection circuit, for enabling the transmission circuit when the measured signal level of the transmission signal is higher than a third predetermined level, and enabling the reception circuit when the mode change signal is not provided.

14. The transmission/reception signal conversion method according to claim 12, further comprising:
providing a mode change signal, at the transmission signal detection circuit, for enabling the transmission circuit when the measured signal level of the transmission signal is higher than a third predetermined level, and enabling the reception circuit when the mode change signal is not provided.

15. A transmission/reception signal conversion method of converting transmission/reception signals exchanged between a first communication device and a second communication device, comprising:
measuring a signal level of a transmission signal inputted from the first communication device at a transmission signal detection circuit, and enabling one of a transmission circuit and a reception circuit depending on the signal level of the transmission signal having been measured; and
converting a frequency of a transmission carrier signal transmitted from the first communication device, at the transmission circuit, to a first predetermined frequency required for communicating with the second communication device and outputting the converted transmission carrier signal to the second communication device when the transmission circuit is enabled.

16. A transmission/reception signal conversion method of converting transmission/reception signals exchanged between a first communication device and a second communication device, comprising:
measuring a signal level of a transmission signal inputted from the first communication device at a transmission signal detection circuit, and enabling one of a transmission circuit and a reception circuit depending on the signal level of the transmission signal having been measured; and
converting a frequency of a reception carrier signal received from the second communication device, at the reception circuit, to a second predetermined frequency required for communicating with the first communication device and outputting the converted reception carrier signal to the first communication device when the reception circuit is enabled.

17. The transmission/reception signal conversion method according to claim 15 further comprising:
providing a mode change signal, at the transmission signal detection circuit, for enabling the transmission circuit when the measured signal level of the transmission signal is higher than a third predetermined level, and enabling the reception circuit when the mode change signal is not provided.

18. The transmission/reception signal conversion method according to claim 16 further comprising:
providing a mode change signal, at the transmission signal detection circuit, for enabling the transmission circuit when the measured signal level of the transmission signal is higher than a third predetermined level, and enabling the reception circuit when the mode change signal is not provided.
